(19) United States
(12) Patent Application Publication
(10) Pub. No.: US 2014/0018961 A1
(43) Pub. Date: Jan. 16, 2014

(54) POOL SYSTEM WITH USER SELECTABLE COMMUNICATION PROTOCOLS AND METHOD OF OPERATING THE SAME

(71) Applicant: Yilcan Guzelgunler, Troy, OH (US)

(72) Inventor: Yilcan Guzelgunler, Troy, OH (US)

(21) Appl. No.: 13/550,150

(22) Filed: Jul. 16, 2012

(51) Int. Cl. G05B 19/00

(52) U.S. Cl. 700/275

(57) ABSTRACT

A pool system comprising a pump system, an external device, a user-controlled input, and a controller. The pump system including a motor and a fluid pump coupled to the motor. The controller including a processor and a memory, the memory storing instructions that, when executed by the processor, cause the controller to: receive an input signal from the user-controlled input; receive data from the external device; interpret the data from the external device according to one of a plurality of communication protocols defined by the input signal from the user-controlled input; control the operation of the motor based on the interpreted data; and reply back to the external device by using the selected protocol.

### BACKGROUND

The invention relates to control applications for a system (such as a pool system). More specifically, some embodiments of the invention relate to systems for controlling the operation of a pump system in a pool system.

In pool system control applications, for example, multiple pool automation systems and user interfaces from different manufacturers may be used. Each manufacturer may have its own communication protocol. When a pool device manufacturer provides a pool device that needs to be integrated into the pool automation system, or needs to be used with a user interface, a communication protocol that is compatible with that system has to be built into the pool device. Therefore, multiple variations of the same pool device must be manufactured, each variation having a different communication protocol to be integrated with a different pool automation system.

### SUMMARY

In one embodiment, the invention provides a pool system comprising a pump system, an external device, a user-controlled input, and a controller. The pump system including a motor and a fluid pump coupled to the motor. The controller including a processor and a memory, the memory storing instructions that, when executed by the processor, cause the controller to: receive an input signal from the user-controlled input; receive data from the external device; interpret the data from the external device according to one of a plurality of communication protocols defined by the input signal from the user-controlled input; control the operation of the motor based on the interpreted data; and reply back to the external device by using the selected protocol.

In another embodiment the invention provides a method of controlling a pool system including a pump system, a user-controlled input, and an external device. The method comprising: receiving an input signal from the user-controlled input; receiving data from the external device; interpreting the data from the external device according to one of a plurality of communication protocols defined by the input signal from the user-controlled input; controlling the operation of the pump system based on the data; and replying back to the external device by using the selected communication protocol.

Other aspects of the invention will become apparent by consideration of the detailed description and accompanying drawings.

### BRIEF DESCRIPTION OF THE DRAWINGS

FIG. 1 is a block diagram of a pool system.

FIG. 2 is a perspective view of a construction of the controller and motor used in the pool system.

FIG. 3 is a block diagram of another construction of a pool system.

FIG. 4 is a block diagram of the controller capable of being used in the pool system.

FIG. 5 illustrates a construction of a user interface module of the controller of FIG. 4.

FIG. 6 illustrates another construction of a user interface module of the controller of FIG. 4.

FIG. 7 is a process illustrating the control of a pool system based on a specified communication protocol.

FIG. 8 is a block diagram of another construction of a pool system.

FIG. 9 illustrates a construction of a user interface module for the pool system of FIG. 8.

FIG. 10 is a process illustrating the control of a pool system based on a specified communication protocol.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In one implementation, a pool system (e.g., swimming pools, hot tubs, spas, whirlpools, jetted tubs, clothes washing machines, and similar apparatus) includes a controller and a user-controlled input. When a user integrates a new pool device into the pool system, the user must set the user-controlled input to the appropriate communication protocol setting. A communication protocol is a set of formats and rules that allow communication between electrical devices, such as a new pool device and a pool system. The communication protocol setting can be based on the type of device or manufacturer of the new pool device. The user-controlled input sends a signal to the controller indicating the appropriate communication protocol to use with the new pool device. The controller then uses the appropriate communication protocol to communicate with the new pool device.

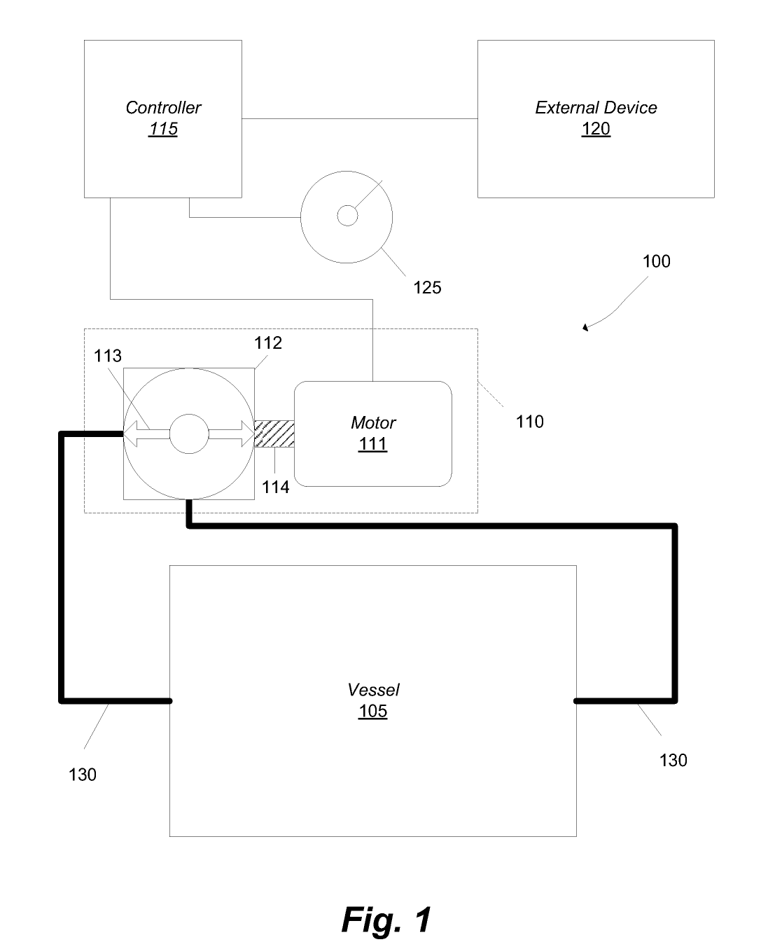

FIG. 1 is a block diagram showing a pool system 100 (e.g., swimming pools, hot tubs, spas, whirlpools, jetted tubs, clothes washing machines, and similar apparatuses). The pool system 100 includes a vessel 105, a pump system 110, a controller 115, an external device 120, and a user-controlled input 125 (e.g., a mechanical switch, magnetic switch, optical switch, keypad, touch screen, etc.). The pump system 110 generally includes a motor 111, a fluid pump 112 coupled to the motor 111, and a fluid agitator 113 located within the fluid pump 112. In some constructions, the vessel 105 is a hollow container such as a tub, pool, or vat that holds a fluid such as, for example, chlorinated water.

As shown in FIG. 1, the pump system 110 is connected in line with the vessel 105 by a piping system 130. The pump system 110 is used to pump the fluid contained within the vessel 105. In some constructions, the motor 111 of the pump system 110 is a brushless, permanent-magnet-synchronous (PMS) motor. As is commonly known, PMS motors include a stator, a permanent magnet rotor, and a power inverter. The motor 111 can further include a programmable device (such as a microcontroller, a digital signal processor, or a similar controller) having a processor and memory. The programmable device of the PMS motor uses software stored in the memory to control the power inverter. The power inverter then provides the appropriate electrical energy to the stator in order to rotate the permanent-magnet rotor at a desired speed. Although motor 111 is described as a PMS motor, the examples and methods herein can be applied to various different motors in other systems.

The motor 111 is coupled to the fluid pump 112 by a shaft 114. The fluid pump 112 contains a fluid agitator 113. In this construction, the fluid agitator 113 is an impeller that controllably moves the fluid contained by the vessel 105. However, other constructions may include other types of fluid agitators.

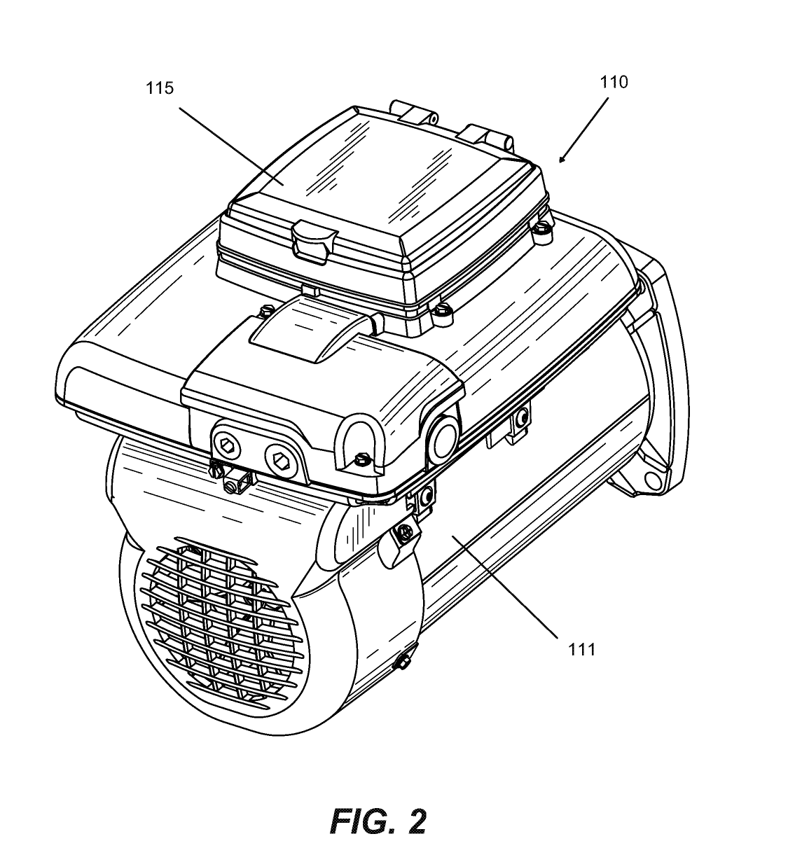

As shown in FIG. 1, the controller 115 is electrically coupled to the motor 111 of the pump system 110. The controller 115 controls the pump system 110, by controlling the on/off functionality and the speed. As shown in FIG. 2, the controller 115 is directly coupled to the pump system 110. For example, the controller 115 can be mounted within the same housing as the motor 111. However, in other constructions, the controller 115 is housed separately from the motor 111 and may be located remotely to the motor 111.

Referring back to FIG. 1, the external device 120, such as a pool automation system, is electrically coupled to the controller 115. The external device 120 may or may not include a separate user interface. Pool automation systems are used to automate and control multiple pool devices, such as other pumps, heaters, chlorinators, lights, etc. Pool automation systems control the multiple devices by sending data to the devices. Other examples of external devices that can be electrically connected to communicate with the controller 115 include user interface systems and networked remote control systems.

In the example of FIG. 1, the external device 120 controls operation of the pump system 110 by transmitting data to the controller 115. The data is interpreted by the controller 115, using a communication protocol. Different manufacturers of external devices (such as external device 120) may implement different baud rates and different protocol structures for communicating with pump systems. The controller 115 determines which communication protocol to use based on the selection of the user-controlled input 125. The controller 115 then uses the selected communication protocol to interpret signals received from the external device 120.

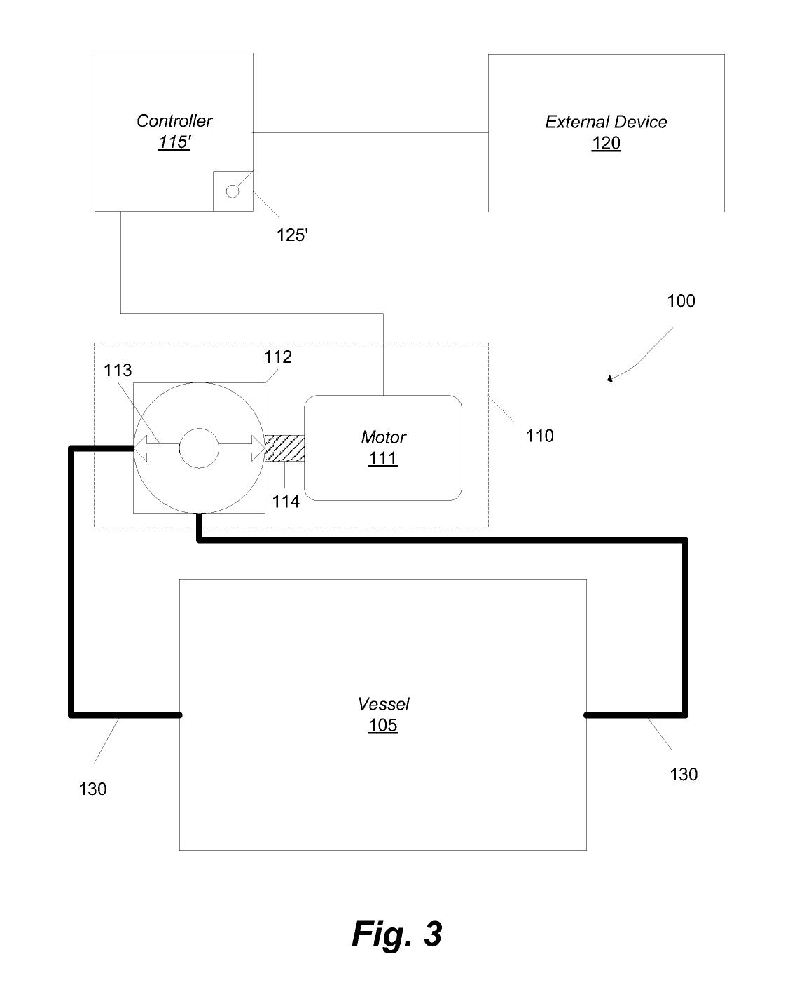

As shown in FIG. 1, the user-controlled input 125 is electrically coupled to the controller 115. A user sets the user-controlled input 125 to indicate the manufacturer of the external device 120 or the specific communication protocol to be used for communication between the controller 115 and the external device 120. In the construction illustrated in FIG. 1, the user-controlled input 125 is a multiple-position mechanical switch separate from the controller 115. However, other types of user-controlled inputs can be used in other constructions, such as touch-screen displays, a plurality of knobs, dials, switches, buttons, etc. In another construction, as illustrated in FIG. 3, the user-controlled input 125′ is integrated into the controller 115′. In this construction, the user-controlled input 125′ can be implemented as a series of DIP switches on the controller or as part of the user interface of the controller 115′. Although discussed as being implemented as a series of DIP switches, other types of user-controlled inputs can be used in other constructions of the user-controlled input 125′, such as touch-screen displays, a plurality of knobs, dials, switches, buttons, etc.

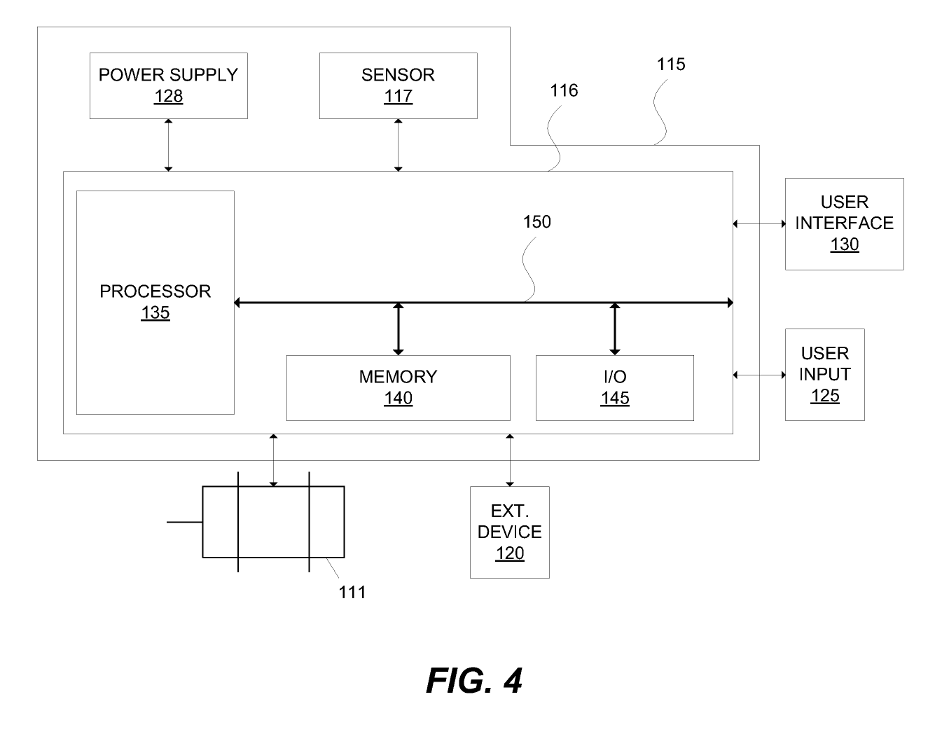

FIG. 4 illustrates the controller 115 associated with the pool system 100. The controller 115 is electrically and/or communicatively connected to a variety of modules or components of the pool system 100. For example, the controller 115 is connected to the motor 111 of the pump system 110, the external device 120, the user-controlled input 125, and a user interface module 130. The controller 115 includes combinations of hardware and software that are operable to, among other things, control the operation of the motor 111, and receive inputs from the user interface 130, the external device 120, and the user-controlled input 125.

In some embodiments, the controller 115 includes a plurality of electrical and electronic components that provide power, operational control, and protection to the components and modules within the controller 115. For example, the controller 115 includes a microcontroller 116, a fault detection circuit or sensor 117, and a power supply module 128. The microcontroller 116 includes, among other things, a processor 135 (e.g., a microprocessor, a microcontroller, or another suitable programmable device), a memory 140, and communication circuitry such as an Input/Output (I/O) unit 145. The processor 135, memory 140, and I/O unit 145, as well as the various modules connected to the microcontroller 116 are connected by one or more control and/or data buses (e.g., common bus 150). The control and/or data buses are shown generally in FIG. 4 for illustrative purposes. The sensor 117 senses parameters and conditions of the controller 115. If at any time a fault occurs, the sensor 117 communicates with the microcontroller 116 to cease operations. In some embodiments, the controller 115 is implemented partially or entirely on a semiconductor (e.g., a field-programmable gate array [“FPGA”] semiconductor) chip. Although not shown in FIG. 4, the controller 115 includes other electronic components that provide power, operational control, and protection to the controller 115, such as an inverter, a rectifier, a power factor correction (PFC) circuitry, and an electromagnetic interference (EMI) filter.

The memory 140 includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, or electronic memory devices. The processor 135 is connected to the memory 140 and executes software instructions that are capable of being stored in a RAM of the memory 140 (e.g., during execution), a ROM of the memory 140 (e.g., on a generally permanent basis), or another non-transitory computer readable medium such as another memory or a disc. Software included in the implementation of the pool system 1 can be stored in the memory 140 of the controller 115. The software includes, for example, firmware, one or more applications, program data, filters, rules, one or more program modules, and other executable instructions. The controller 115 is configured to retrieve from memory and execute, among other things, instructions related to the control processes and methods described herein. In other constructions, the controller 115 includes additional, fewer, or different components.

The power supply module 128 supplies a nominal AC or DC voltage to the controller 115 or other components or modules of the pool system 100. The power supply module 128 is powered by, for example, a power source having nominal line voltages between 100V and 240V AC and frequencies approximately 50-60 Hz. The power supply module 128 is also configured to supply lower voltages to operate circuits and components within the controller 115 or pool system 100. In other constructions, the controller 115 or other components and modules within the pool system 100 are powered by one or more batteries or battery packs, or another grid-independent power source (e.g., a generator, a solar panel, etc.).

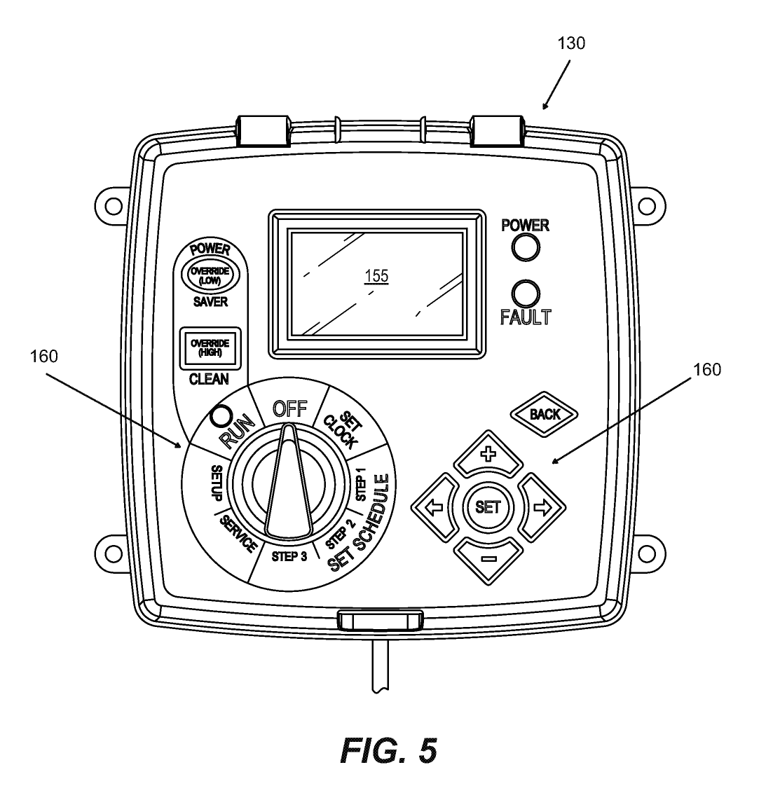

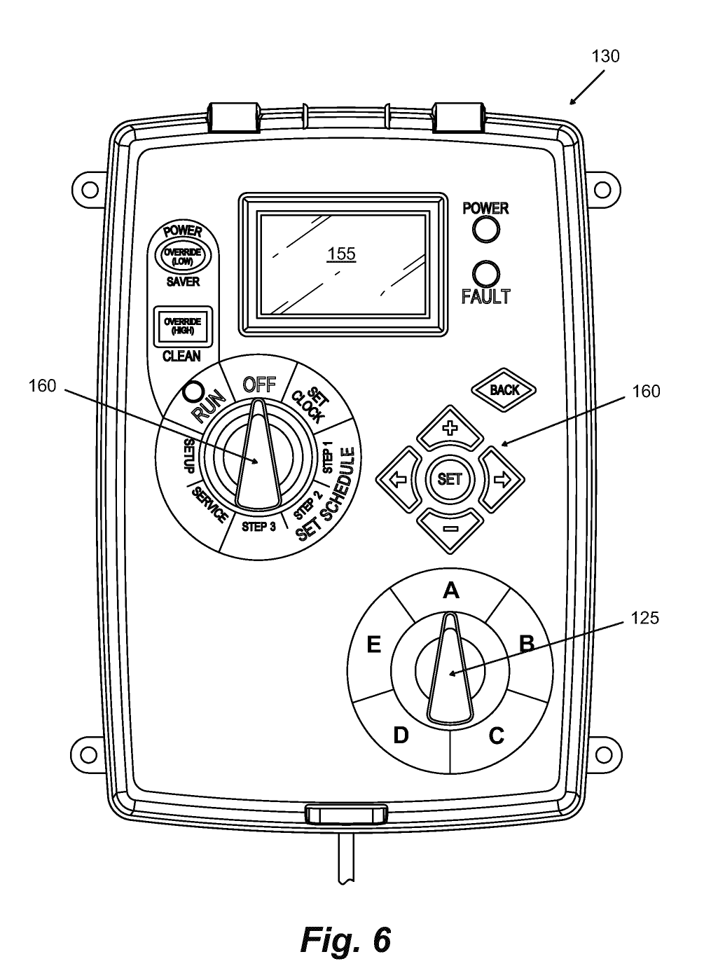

FIG. 5 illustrates the user interface module 130. The user interface module 130 is used to control the pool system 100. For example, the user interface module 130 is operably coupled to the controller 115 to control operation of the pump system 110. The user interface module 130 includes a combination of digital and analog input or output devices required to achieve a desired level of control and monitoring for the pool system 100. For example, in the illustrated construction shown in FIG. 5, the user interface module 130 includes a display 155 and input devices 160 (e.g., a touch-screen display, a plurality of knobs, dials, switches, buttons, etc.). As shown in FIG. 6, in another construction the user interface module 130 and user-controlled input 125 are combined into a single device to control the pool system 100 as well as set the appropriate communication protocol to be used for communication between the controller 115 and the external device 120.

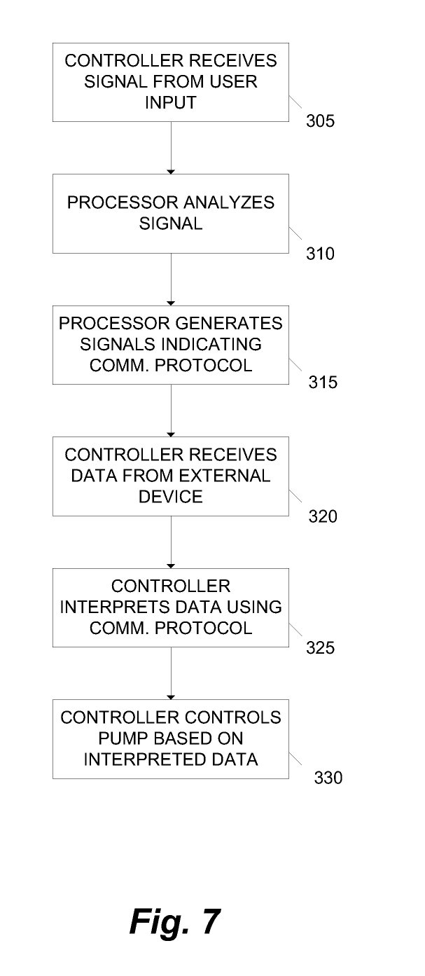

FIG. 7 is a process 300 of controlling the pool system 100. Although the process 300 is shown as a linear process, the order of the steps may be performed in a different process order, or may be performed simultaneously. The controller 115 receives a signal from the user-controlled input 125 (Step 305). The processor 135 executes a software program, stored in the memory 140, for analyzing the received signal (Step 310). The processor 135 generates one or more control signals indicating the specific communication protocol being used (Step 315). The controller 115 receives data from the external device 120 (Step 320). The controller 115 interprets the data from the external device 120 using the specified communication protocol (Step 325). The controller 115 controls the motor 111 of the pump system 110 based on the interpreted data (Step 330).

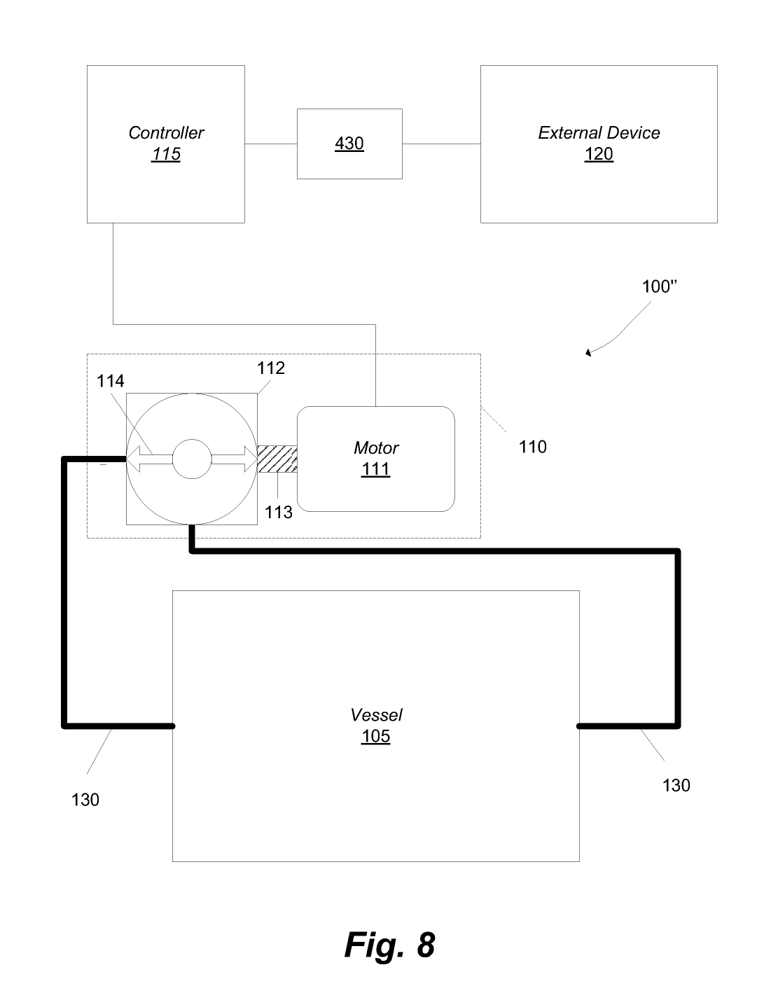

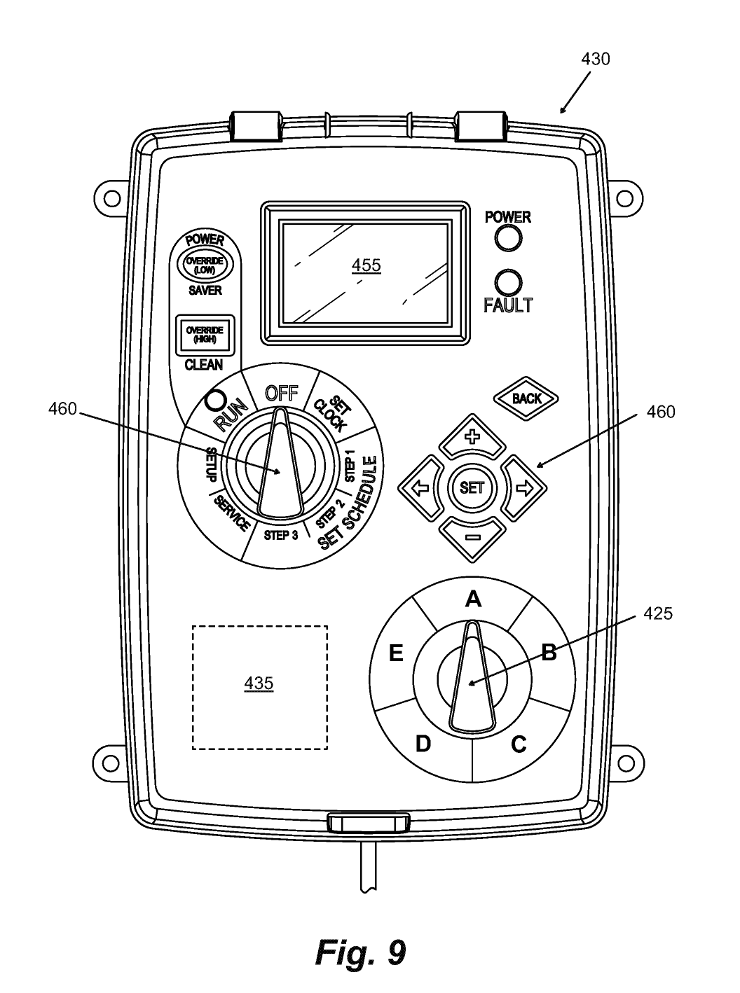

In another construction, illustrated in FIG. 8, the user interface module 430 acts as an interpreter between the controller 115 and the external device 120. As shown in FIG. 9, the user interface module 430 includes a UI controller 435, a user-controller input 425, a display 455, and input devices 460. The UI controller 435 is similar in physical construction to the controller 115. The UI controller 435 includes a processor, a memory, an I/O unit, as well as other electrical and electronic components that provide power, operational control, and protection to the components and modules within the UI controller 435. The external device 120 controls operation of the pump system 110 by transmitting data to the user interface module 430. The UI controller 435 of the user interface module 430 interprets the data using a communication protocol. The user-controlled input 425 is set to indicate the specific communication protocol to be used for communication between the external device 120 and user interface module 430. Once the data is interpreted by the UI controller 435, the user interface module 430 communicates the interpreted data to the controller 115. The controller 115 operates the pump system 110 based on the interpreted data received from the user interface module 430. In another construction, the user-controlled input 425 is not included within the user interface module 430, rather the user-controlled input 425 is a separate device electrically coupled to the user interface module 430.

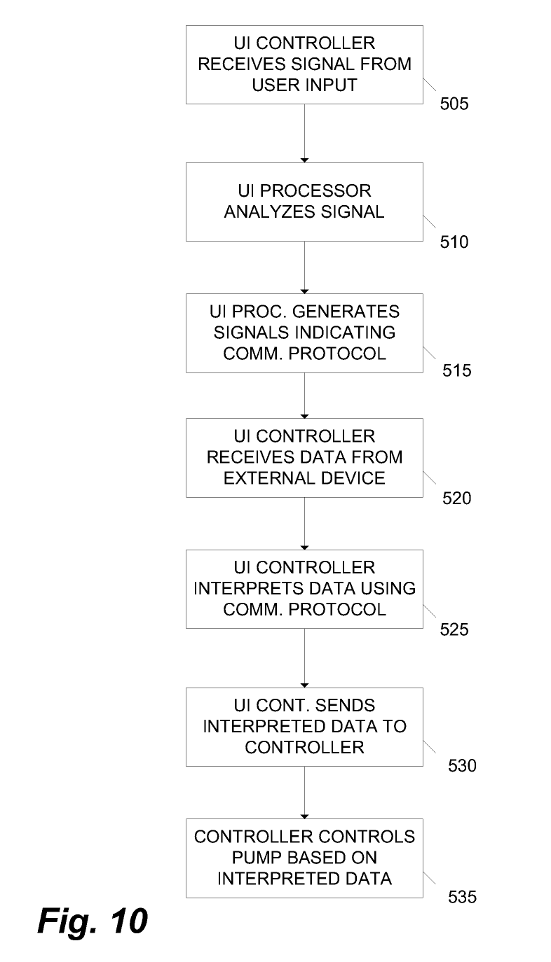

FIG. 10 is a process 500 of controlling the pool system 100″ according to the construction illustrated in FIG. 7. Although the process 500 is shown as a linear process, the order of steps may be performed in a different process order, or may be performed simultaneously. The UI controller 435 receives a signal from the user-controlled input 425 (Step 505). The processor of the UI controller 435 executes a software program, stored in the memory of the UI controller 435, for analyzing the received signal (Step 510). The processor of the UI controller 435 generates one or more control signals indicating the specific communication protocol being used (Step 515). The UI controller 435 receives data from the external device 120 (Step 520). The UI controller 435 interprets the data from the external device 120 using the specified communication protocol (Step 525). The UI controller 435 sends the interpreted data to the controller 115 (Step 530). The controller 115 controls the motor 111 of the pump system 110 based on the interpreted data (Step 535).

Thus, the invention provides, among other things, a new and useful pool system controller with user selectable communications protocol. Various features and advantages of the invention are set forth in the following claims.

What is claimed is:

1. A pool system comprising:
a pump system including a motor and a fluid pump coupled to the motor;
an external device;
a user-controlled input; and
a controller including a processor and a memory, the memory storing instructions that, when executed by the processor, cause the controller to:
receive an input signal from the user-controlled input,
receive data from the external device,
interpret the data from the external device according to one of a plurality of communication protocols defined by the input signal from the user-controlled input,
control the operation of the motor based on the interpreted data, and
reply back to the external device by using the selected protocol.

2. The pool system of claim 1, wherein the user-controlled input is integrated into the controller.

3. The pool system of claim 1, wherein the plurality of communication protocols are saved in the memory.

4. The pool system of claim 1, wherein the user-controlled input is at least one of a mechanical switch, a magnetic switch, or an optical switch, and wherein a position of the user-controlled input corresponds to one of the plurality of communication protocols.

5. The pool system of claim 4, wherein the input signal indicates the position of the user-controlled input.

6. The pool system of claim 1, further comprising a user interface module for controlling the operation of the motor, the user interface module including the user-controlled input.

7. The pool system of claim 1, wherein the external device is at least one of a pool automation system, a user interface, or a networked remote control system.

8. The pool system of claim 1, wherein the plurality of communication protocols comprise sets of instructions that, when executed by the processor, cause the controller to interpret the received data and identify a command for controlling the operation of the motor.

9. A method of controlling a pool system including a pump system, a user-controlled input, and an external device, the method comprising:
receiving an input signal from the user-controlled input;
receiving data from the external device;
interpreting the data from the external device according to one of a plurality of communication protocols defined by the input signal from the user-controlled input;
controlling the operation of the pump system based on the interpreted data; and
replying back to the external device by using the selected communication protocol.

10. The method of claim 9, wherein the plurality of communication protocols are saved in a memory.

11. The method of claim 9, wherein the user-controlled input is at least one of a mechanical switch, a magnetic switch, or an optical switch, where a position of the user-controlled input corresponds to one of the plurality of communication protocols.

12. The method of claim 11, wherein the input signal indicates the position of the user-controlled input.

13. The method of claim 9, wherein the external device is at least one of a pool automation system, a user interface, or a networked remote control system.

14. The method of claim 9, wherein the plurality of communication protocols comprise sets of instructions to interpret the data and identify a command for controlling the operation of the pump system.

15. A controller for controlling a pool system, the pool system including a pump system, a user-controlled input, and an external device, the controller comprising:
a processor and a memory, the memory storing instructions that, when executed by the processor, cause the controller to:
receive an input signal from the user-controlled input,
receive data from the external device,
interpret the data from the external device according to one of a plurality of communication protocols defined by the input signal from the user-controlled input, and
control the operation of the pump system based on the data.

16. The controller of claim 15, wherein the user-controlled input is integrated into the controller.

17. The pool system of claim 15, wherein the plurality of communication protocols are saved in the memory.

18. The pool system of claim 15, wherein the user-controlled input is at least one of mechanical switch, a magnetic switch, or an optical switch, where a position of the user-controlled input corresponds to one of the plurality of communication protocols.

19. The pool system of claim 18, wherein the input signal indicates the position of the user-controlled input.

20. The pool system of claim 15, further comprising a user interface module for controlling the operation of the motor, the user interface module including the user-controlled input.

21. The pool system of claim 15, wherein the external device is at least one of a pool automation system, a user interface, or a networked remote control system.

22. The pool system of claim 15, wherein the plurality of communication protocols comprise sets of instructions that, when executed by the processor, cause the controller to interpret the data and identify a command for controlling the operation of the pump system.

23. A pool system comprising:
a pump system including a motor and a fluid pump coupled to the motor;
an external device;
a user-controlled input;
a user-interface controller including a processor and a memory, the memory storing instructions that, when executed by the processor, cause the controller to:
receive an input signal from the user-controlled input,
receive data from the external device,
interpret the data from the external device according to one of a plurality of communication protocols defined by the input signal from the user-controlled input; and
a controller including a processor and a memory, the memory storing instructions that, when executed by the processor, cause the controller to:
receive the interpreted data from the user-interface controller, and
control the operation of the motor based on the interpreted data.
